(19) United States
(12) Patent Application Publication
(10) Pub. No.: US 2013/0063446 A1
(43) Pub. Date: Mar. 14, 2013

(54) Scenario Based Animation Library

(71) Applicants: Bonny P. Lau, Bellevue, WA (US); Song Zou, Bellevue, WA (US); Wei Zhang, Redmond, WA (US); Jason D. Beaumont, Seattle, WA (US); Brian D. Beck, Redmond, WA (US)

(72) Inventors: Bonny P. Lau, Bellevue, WA (US); Song Zou, Bellevue, WA (US); Wei Zhang, Redmond, WA (US); Jason D. Beaumont, Seattle, WA (US); Brian D. Beck, Redmond, WA (US)

(73) Assignee: Microsoft Corporation, Redmond, WA (US)

(21) Appl. No.: 13/229,695

(22) Filed: Sep. 10, 2011

(51) Int. Cl. G06T 13/00

(52) U.S. Cl. 345/473

(57) ABSTRACT

Various embodiments provide a library of animation descriptions based upon various common user interface scenarios. Application developers can query the animation library for animations based on a user's interaction with the user interface. The library defines usage of transformation primitives, storyboarding of the transformation primitives and associated timing functions that are used to create particular animations. These definitions can be provided to a calling application so that the application can implement an animation that utilizes the storyboarded transformation primitives.

### BACKGROUND

Many common user interface scenarios leverage transitions and animations to create a more fluid visual effect to tie the user experience together. For example, when transitioning between applications, one application may visually fade away while the other application visually fades in. To create a uniform, standardized user experience, motion should be applied in a consistent manner such that the motion feels like it tells a single, coherent story. Yet to date, animations tend to be performed in a piecemeal fashion using different elements such as transitions, rotations, and the like. This causes developers or animators to have to individually program code to perform these different animation elements, thus leading to an inconsistent user experience across the relevant system.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various embodiments provide a library of animation descriptions based upon various common user interface scenarios. Application developers can cause the animation library to be queried for animations based on a user's interaction with the user interface. The library defines usage of transformation primitives, storyboarding of the transformation primitives and associated timing functions that are used to create particular animations. These definitions can be provided to a calling application so that the application can implement an animation that utilizes the storyboarded transformation primitives.

Utilizing the animation library, application developers can map scenarios in their particular user interfaces to matching animations without necessarily understanding the specifics behind a particular animation. This abstraction not only simplifies an application developer's task, but it also allows the animation design to be consistently applied across a particular system.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation in accordance with one or more embodiments.

FIG. 2 is an illustration of a system in an example implementation showing FIG. 1 in greater detail.

FIG. 3 is an illustration of an example animation library in accordance with one or more embodiments.

FIG. 4 is an illustration of an example collection of animation definitions in accordance with one or more embodiments.

FIG. 5 is an illustration of an example XML-defined storyboard in accordance with one or more embodiments.

FIG. 6 is an illustration of an example XML-defined storyboard and various associated user interface states to which the storyboard pertains.

FIG. 7 is an illustration, related to FIG. 6, which visually shows the timing relationships between the transformations defined in the FIG. 6 XML-defined storyboard.

FIG. 8 is a flow diagram that describes steps in a method in accordance with one or more embodiments.

FIG. 9 illustrates an example computing device that can be utilized to implement various embodiments described herein.

### DETAILED DESCRIPTION

### Overview

Various embodiments provide a library of animation descriptions based upon various common user interface scenarios. Application developers can cause the animation library to be queried for animations based on a user's interaction with the user interface. The library defines usage of transformation primitives, storyboarding of the transformation primitives and associated timing functions that are used to create particular animations. These definitions can be provided to a calling application so that the application can implement an animation that utilizes the storyboarded transformation primitives.

Utilizing the animation library, application developers can map scenarios in their particular user interfaces to matching animations without necessarily understanding the specifics behind a particular animation. This abstraction not only simplifies an application developer's task, but it also allows the animation design to be consistently applied across a particular system.

For example, in a particular system, various applications that have a “pagination” scenario can utilize the animation library to transition based on a “pagination” animation definition that appears in the animation library. Accordingly, paginations across multiple different applications can be implemented in a standardized manner. Furthermore, the animation library allows for unified, integrated future updates.

In one or more embodiments, the animation library can be utilized across a variety of different platforms and, in this sense, the animation library can be platform-agnostic.

Accordingly, the animation library provides a central location where uniform, standardized descriptions of various animations reside. The definitions are based on user interface scenarios which commonly occur within a particular user interface. Commonly-occurring user interface scenarios can include, by way of example and not limitation, portions of a user interface fading in or out, dialogs or other portions of the user interface sliding on or off the screen, effects that occur when user interface elements are touched or otherwise engaged, effects that occur when new user interface elements appear on the screen, and/or what occurs when a window wishes to issue a user notification. The animation library provides a level of abstraction away from rendering and composition technology which leads to its platform-agnostic properties mentioned above. Furthermore, various embodiments utilize a standardized language for describing animations that can operate on multiple elements, arrays of elements, and the like.

In the following discussion, an example environment is first described that is operable to employ the techniques described herein. Example illustrations of the various embodiments are then described, which may be employed in the example environment, as well as in other environments. Accordingly, the example environment is not limited to performing the described embodiments and the described embodiments are not limited to implementation in the example environment.

Example Environment

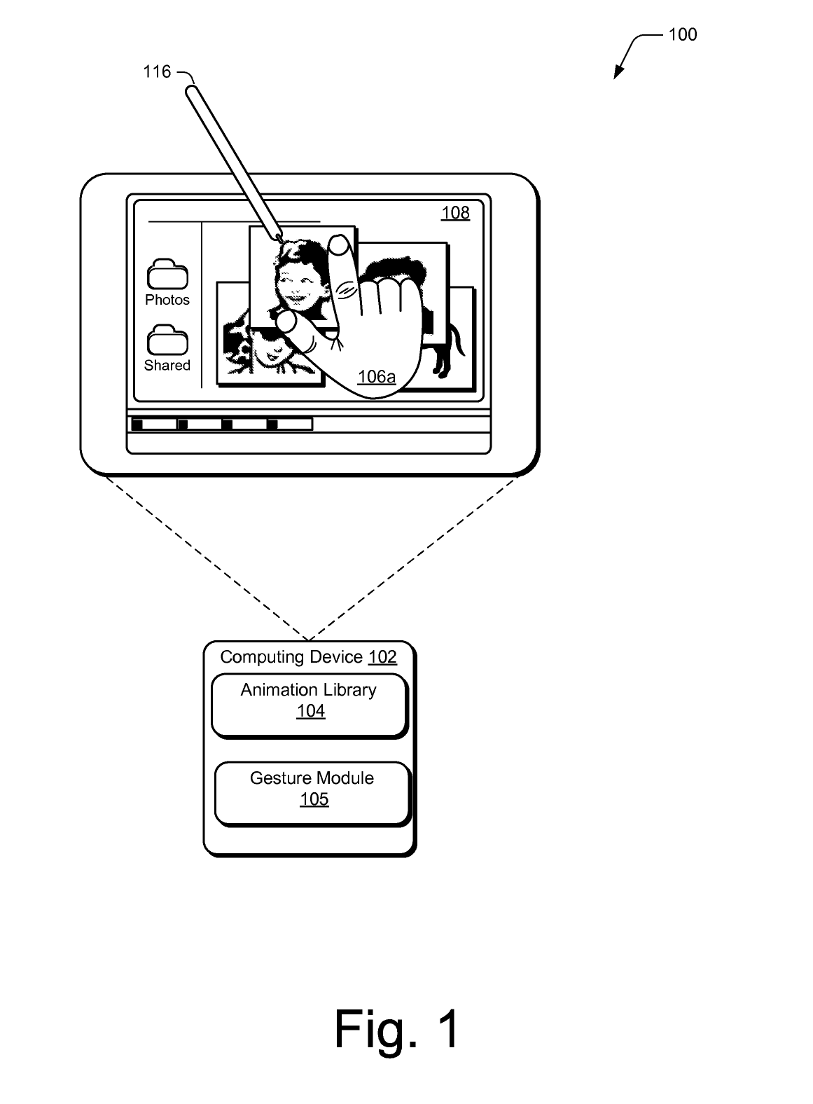

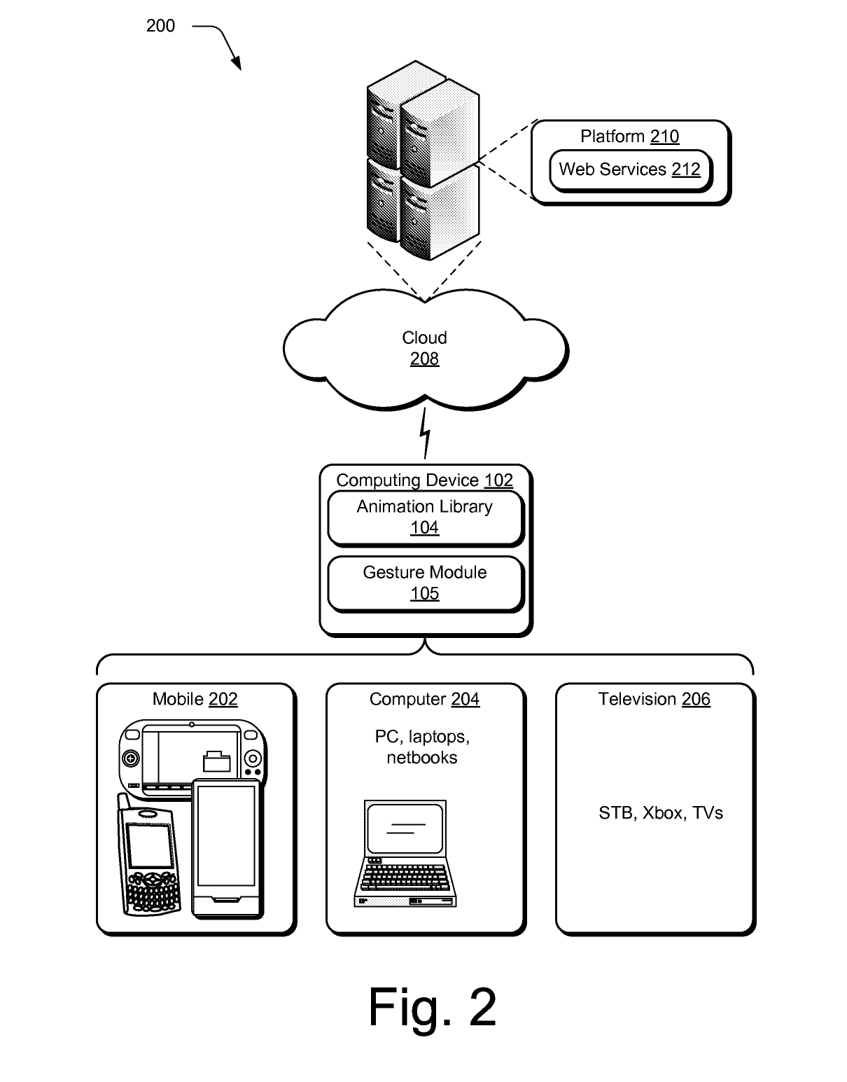

FIG. 1 is an illustration of an environment 100 in an example implementation that is operable to employ the animation techniques described in this document. The illustrated environment 100 includes an example of a computing device 102 that may be configured in a variety of ways. For example, the computing device 102 may be configured as a traditional computer (e.g., a desktop personal computer, laptop computer, and so on), a mobile station, an entertainment appliance, a set-top box communicatively coupled to a television, a wireless phone, a netbook, a game console, a handheld device, and so forth as further described in relation to FIG. 2. Thus, the computing device 102 may range from full resource devices with substantial memory and processor resources (e.g., personal computers, game consoles) to a low-resource device with limited memory and/or processing resources (e.g., traditional set-top boxes, hand-held game consoles). The computing device 102 also includes software that causes the computing device 102 to perform one or more operations as described below.

Computing device 102 includes an animation library 104 to provide animation functionality as described in this document. The animation library can be implemented in connection with any suitable type of hardware, software, firmware or combination thereof. In at least some embodiments, the animation library is implemented in software that resides on some type of tangible, computer-readable storage medium examples of which are provided below.

Animation library 104 is representative of functionality that provides a library of animation descriptions based upon various common user interface scenarios. The animation library can be queried for animations based on a user's interaction with the user interface. The library defines usage of transformation primitives, storyboarding of the transformation primitives and associated timing functions that are used to create particular animations. These definitions can be provided to a calling application so that the application can implement an animation that utilizes the storyboarded transformation primitives.

Accordingly, as noted above, the animation library provides a central location where uniform, standardized descriptions of various animations reside. The definitions are based on user interface scenarios which commonly occur within a particular user interface. The animation library provides a level of abstraction away from rendering and composition technology which leads to its platform-agnostic properties mentioned above. Furthermore, various embodiments utilize a standardized language for describing animations that can operate on multiple elements, arrays of elements, and the like.

Computing device 102 also includes a gesture module 105 that recognizes gestures that can be performed by one or more fingers, and causes operations to be performed that correspond to the gestures. The gestures may be recognized by module 105 in a variety of different ways. For example, the gesture module 105 may be configured to recognize a touch input, such as a finger of a user's hand 106a as proximal to display device 108 of the computing device 102 using touchscreen functionality. Module 105 can be utilized to recognize single-finger gestures and bezel gestures, multiple-finger/same-hand gestures and bezel gestures, and/or multiple-finger/different-hand gestures and bezel gestures.

The computing device 102 may also be configured to detect and differentiate between a touch input (e.g., provided by one or more fingers of the user's hand 106a) and a stylus input (e.g., provided by a stylus 116). The differentiation may be performed in a variety of ways, such as by detecting an amount of the display device 108 that is contacted by the finger of the user's hand 106 versus an amount of the display device 108 that is contacted by the stylus 116.

Thus, the gesture module 105 may support a variety of different gesture techniques through recognition and leverage of a division between stylus and touch inputs, as well as different types of touch inputs.

FIG. 2 illustrates an example system 200 showing the animation library 104 and gesture module 105 as being implemented in an environment where multiple devices are interconnected through a central computing device. The central computing device may be local to the multiple devices or may be located remotely from the multiple devices. In one embodiment, the central computing device is a “cloud” server farm, which comprises one or more server computers that are connected to the multiple devices through a network or the Internet or other means.

In one embodiment, this interconnection architecture enables functionality to be delivered across multiple devices to provide a common and seamless experience to the user of the multiple devices. Each of the multiple devices may have different physical requirements and capabilities, and the central computing device uses a platform to enable the delivery of an experience to the device that is both tailored to the device and yet common to all devices. In one embodiment, a “class” of target device is created and experiences are tailored to the generic class of devices. A class of device may be defined by physical features or usage or other common characteristics of the devices. For example, as previously described the computing device 102 may be configured in a variety of different ways, such as for mobile 202, computer 204, and television 206 uses. Each of these configurations has a generally corresponding screen size and thus the computing device 102 may be configured as one of these device classes in this example system 200. For instance, the computing device 102 may assume the mobile 202 class of device which includes mobile telephones, music players, game devices, and so on. The computing device 102 may also assume a computer 204 class of device that includes personal computers, laptop computers, netbooks, and so on. The television 206 configuration includes configurations of device that involve display in a casual environment, e.g., televisions, set-top boxes, game consoles, and so on. Thus, the techniques described herein may be supported by these various configurations of the computing device 102 and are not limited to the specific examples described in the following sections.

Cloud 208 is illustrated as including a platform 210 for web services 212. The platform 210 abstracts underlying functionality of hardware (e.g., servers) and software resources of the cloud 208 and thus may act as a “cloud operating system.” For example, the platform 210 may abstract resources to connect the computing device 102 with other computing devices. The platform 210 may also serve to abstract scaling of resources to provide a corresponding level of scale to encountered demand for the web services 212 that are implemented via the platform 210. A variety of other examples are also contemplated, such as load balancing of servers in a server farm, protection against malicious parties (e.g., spam, viruses, and other malware), and so on.

Thus, the cloud 208 is included as a part of the strategy that pertains to software and hardware resources that are made available to the computing device 102 via the Internet or other networks. For example, the animation library 104 may be implemented in part on the computing device 102 as well as via a platform 210 that supports web services 212.

The gesture techniques supported by the gesture module may be detected using touchscreen functionality in the mobile configuration 202, track pad functionality of the computer 204 configuration, detected by a camera as part of support of a natural user interface (NUI) that does not involve contact with a specific input device, and so on. Further, performance of the operations to detect and recognize the inputs to identify a particular gesture may be distributed throughout the system 200, such as by the computing device 102 and/or the web services 212 supported by the platform 210 of the cloud 208.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on or by a processor (e.g., CPU or CPUs). The program code can be stored in one or more computer readable memory devices. The features of the gesture techniques described below are platform-independent, meaning that the techniques may be implemented on a variety of commercial computing platforms having a variety of processors.

In the discussion that follows, various sections describe example various embodiments. A section entitled “Example Animation Library” describes an example animation library in accordance with one or more embodiments. Following this, a section entitled “Example Storyboard” describes an example storyboard in accordance with one or more embodiments. Next, a section entitled “Example Method” describes an example method in accordance with one or more embodiments. Last, a section entitled “Example Device” describes aspects of an example device that can be utilized to implement one or more embodiments.

Having described example operating environments in which the animation library can be utilized, consider now a discussion of an example animation library in accordance with one or more embodiments.

Example Animation Library

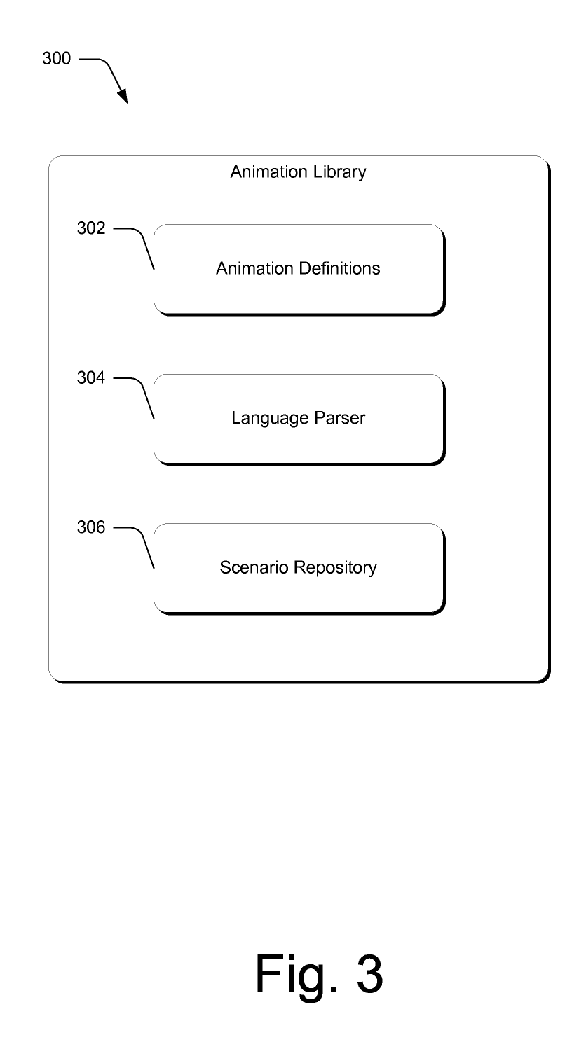

FIG. 3 illustrates an example animation library in accordance with one or more embodiments generally at 300. In this example, animation library 300 includes a collection of animation definitions 302, a language parser 304, and a scenario repository 306.

In one or more embodiments, the animation definitions collection 302 includes a set of scenario descriptions that are expressed in a standardized language. The scenario descriptions provide predefined animations and visual styles for use by various systems that can include applications, including native applications, web applications, and managed applications. The animation definitions contained within the collection provide for consistent animations and visual styles in various scenarios. The animation definitions within the collection define usage of transformation primitives, storyboarding of the transformation primitives and associated timing functions that are used to create particular animations. These definitions can be provided to a calling application so that the application can implement an animation that utilizes the storyboarded transformation primitives.

As noted above, the scenario descriptions are expressed in a standardized language. Any suitable standardized language can be utilized without departing from the spirit and scope of the claimed subject matter. In at least some embodiments, the standardized language comprises eXtensible Markup Language (XML), examples of which are provided below.

In illustrated and described embodiment, language parser 304 is configured to interact with the collection of animation definitions 302 to process the definitions and graphical assets associated therewith, and enable the definitions to be accessed by a calling application.

Scenario repository 306 includes a plurality of application program interfaces which enable calling applications to access the scenario descriptions residing in the collection of animation definitions.

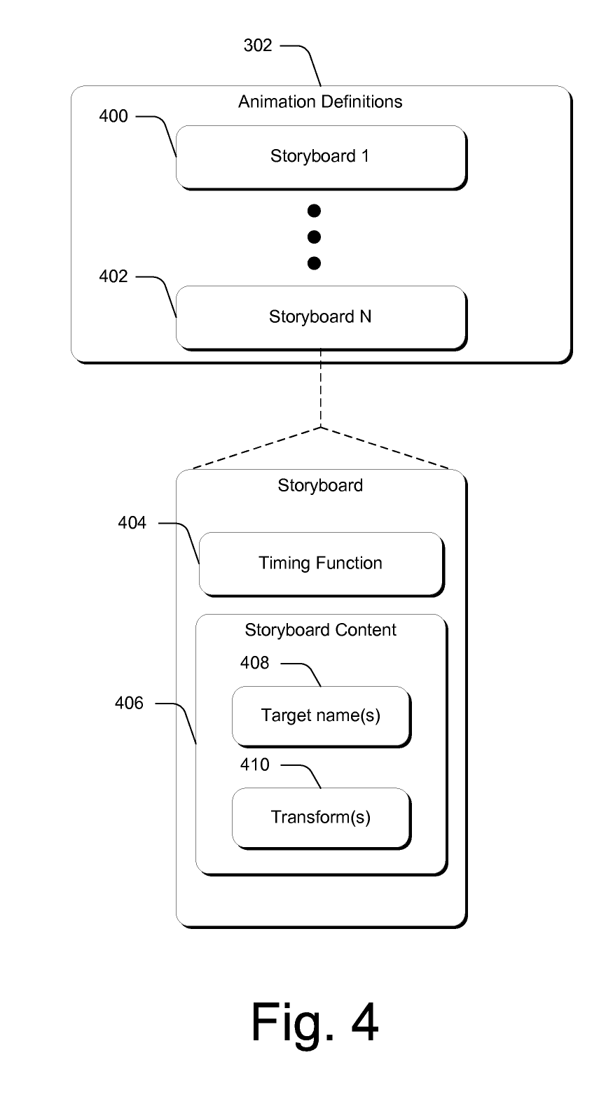

FIG. 4 illustrates the collection of animation definitions 302 in more detail in accordance with one or more embodiments. In this example, each animation definition or scenario description is represented as an individual storyboard. Each storyboard is configured to define or describe an animation that can be utilized by a calling application. Any suitable number of storyboards 400, 402 can be included within the collection of animation definitions 302.

In the illustrated and described embodiment, each storyboard includes one or more timing function 404 and storyboard content 406. As will be appreciated by the skilled artisan, timing functions in animations govern the speed at which actions are illustrated to take place, as well as other properties. For example, in a tablet environment, if a user taps on the display screen sufficient to cause a keyboard to be exposed, a timing function governs the speed and manner in which the keyboard is exposed to the user in the user interface. Likewise, if the user interface is to transition between two different applications, a timing function governs the speed and manner in which the applications transition between one other.

Storyboard content 406 includes one or more target names 408 and one or more transforms 410. The target names 408 describe the targets that are the subject of the information. Transforms 410 describe the individual transformation primitives that are to be used in the particular animation, as well as properties associated with the transformation primitives as will become apparent below.

Having considered an example collection of animation definitions 302, consider now a discussion of an example storyboard described in a standardized language in the form of XML, in accordance with one or more embodiments.

Example Storyboard

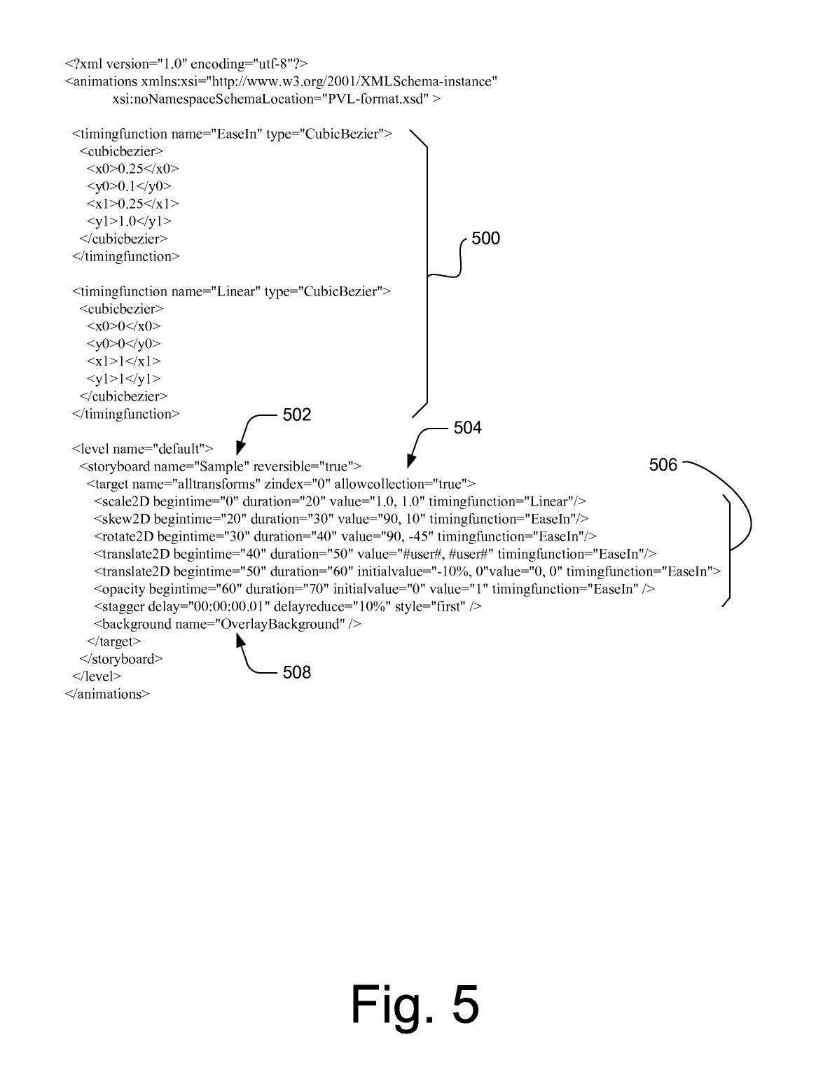

FIG. 5 illustrates an example storyboard that is described in XML in accordance with one or more embodiments. In this example the storyboard employs two timing functions, generally at 500, each of the type “CubicBezier”. A first of the timing functions is named “EaseIn” and a second of the timing functions is named “Linear”. The XML encapsulation of each timing function includes parameters that are to be utilized to implement the timing function.

Further down in the XML representation of the storyboard appears the storyboard's name 502—here “Sample”. The XML also includes a target name and other properties associated with the target name at 504, and a collection of transformation primitives shown generally at 506. The collection of transformation primitives 506 includes the transformation name and various parameters pertaining to how the particular transformation is to be applied to the named target. For example, the first transformation primitive that appears is “scale2D”, along with various parameters that pertain to how this particular transformation is to be applied. In this example, the parameters include a begin time and a duration, as well as values associated with implementing the transformation, and a timing function that is to be used with the transformation.

In this example, there are seven transformations that are to be applied including one scaling transformation, one skew transformation, one rotate transformation, two translate transformations, one opacity transformation, and one staggered transformation. In addition, a static image 508 called “OverlayBackground” is defined and is to be used in implementing the animation associated with this particular storyboard.

Accordingly, the animation defined by this particular storyboard can be utilized by a calling application to implement a particular animation associated with a user interface scenario encountered by the application pursuant to a user's interaction with an application's user interface.

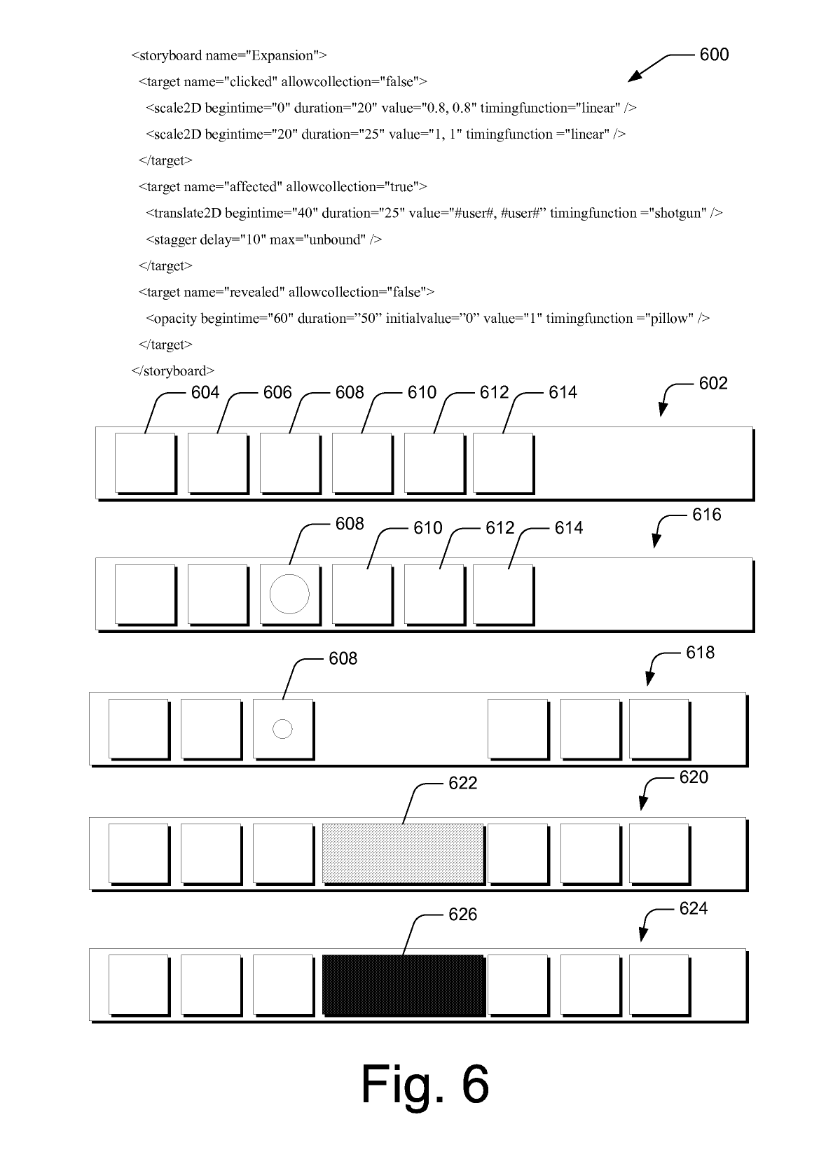

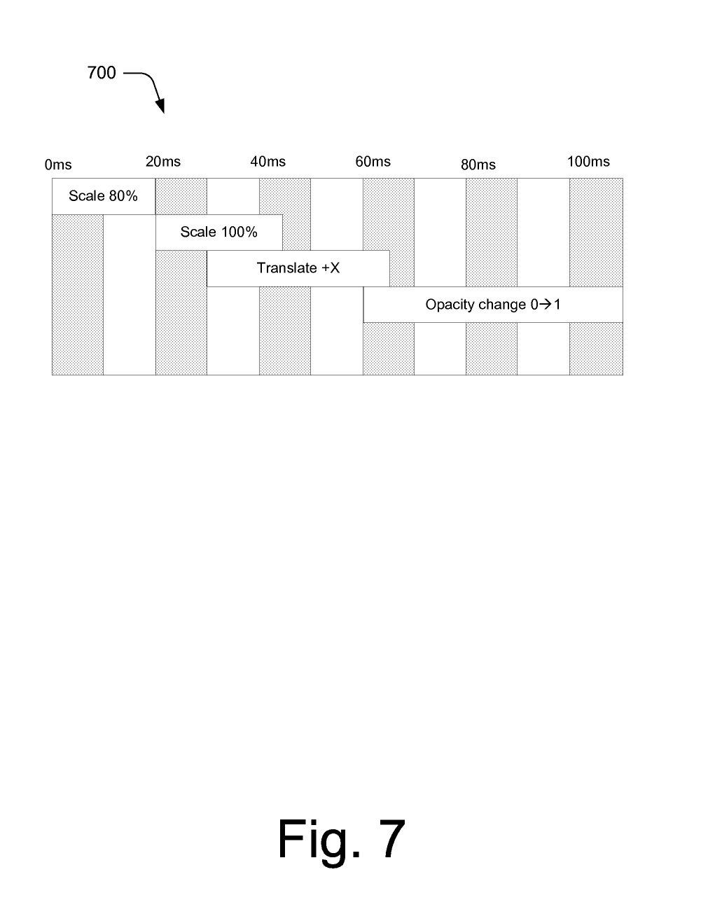

As an example, consider FIGS. 6 and 7, which illustrate various aspects of an example XML-defined storyboard. Specifically, FIG. 6 illustrates the XML-defined storyboard at 600 and, just beneath, the user interface experience that corresponds to the animation defined by storyboard 600. Correspondingly, FIG. 7 illustrates a visual representation of the various transformation primitives and their associated timing relationships as set forth in the XML-defined storyboard 600.

Referring first to the XML-defined storyboard 600, an animation named “Expansion” is defined. The animation “Expansion” describes how various elements expand to accommodate an element that can be clicked on by a user, and how a new element can be inserted in between various elements. In this example, there are three target types—a first named“clicked”, a second named “affected”, and a third named “revealed.”

A “clicked” target corresponds to an element upon which the user clicks. An “affected” target corresponds to an element or elements that move responsive to an element being clicked. A “revealed” target corresponds to an element that is to appear within a space that is defined between a clicked element and affected elements.

Referring to the XML-defined storyboard 600, a property of each target called “allowcollection” defines whether multiple elements may be included within the particular target. So, for example, the target types “clicked” and “affected” do not allow for multiple elements. However, the target type “affected” does allow for multiple elements within a particular target.

The target type “clicked” includes two scaling transformations having the stated durations, values, and timing functions. The target type “affected” has a translation transformation and a stagger transformation having the stated durations, values and, for the translation, the timing function. The target type “revealed” has an opacity transformation with the stated duration, values, and timing function.

Referring now to the user interface experience just beneath the XML-defined storyboard, a number of different user interface states are shown respectively at 602, 616, 618, 620, and 624.

User interface state 602 constitutes the state of the user interface prior to any user interaction. In this state, a plurality of elements appear within the user interface. These elements are shown at 604, 606, 608, 610, 612, and 614.

In user interface state 616, assume that a user has clicked upon element 608, thus making it the “clicked” target. As the clicked target, the scaling transformations that are defined in the XML are applied to this element. In FIG. 7, the visual representation of the timing relationships of the storyboard is shown generally at 700. Here, the transformations that are applied to element 608 in FIG. 6 are shown as the top two entries. By clicking on element 608, the user's action has defined elements 610, 612, and 614 to be the “affected” elements.

Accordingly, in user interface state 618 these elements are translated to the right in accordance with the translation transformation and its associated parameters as defined in the XML. This corresponds to the third entry in the visual representation of the timing relationships in FIG. 7.

Referring to user interface state 620, a new element 622 is “revealed” in accordance with the opacity transformation defined in the XML. This element fades in until it is fully faded in. This is shown in user interface state 624 where the fully faded-in element appears as element 626.

Having considered an example storyboard in accordance with one or more embodiments, consider now a discussion of an example method in accordance with one or more embodiments.

Example Method

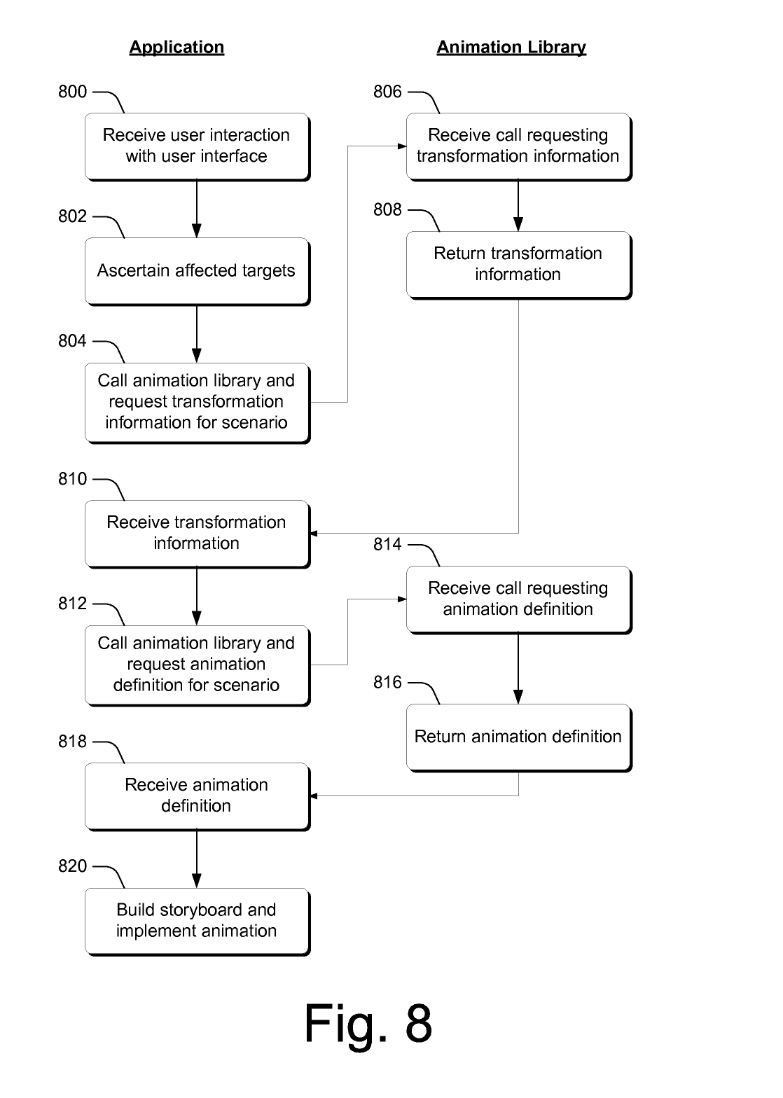

FIG. 8 is a flow diagram that describes steps in a method accordance with one or more embodiments. The method can be performed in connection with any suitable hardware, software, firmware, or combination thereof. In at least some embodiments, the method can be performed by software embodied on some type of computer-readable storage medium. In this particular flow diagram, there are two columns, one designated “Application” and another designated “Animation Library”. Each column represents the entity that performs a particular act or operation.

Step 800 receives a user interaction associated with a user interface. Any suitable type of user interaction can be received. For example, the user interaction could be through the form of a gesture, such as a flick or a swipe, that falls within a particular scenario. For example, a user may tap or flick an element that is presented through a user interface. For example, a user may press down on a tile or other user interface element. Step 802 ascertains, responsive to receiving the user interaction, one or more affected targets. Step 804 calls an animation library and requests transformation information associated with the particular scenario. This step can be implemented in any suitable way. For example, in at least some embodiments, the application can include, for the particular scenario, a storyboard ID and a target name or names. In at least some embodiments, this step can ask how many transformations are available for the storyboard ID and the particular target name or names.

Step 806 receives the call requesting transformation information and processes the information accordingly. Processing can take place in any suitable way. For example, the call can be received by a scenario repository, such as scenario repository 306 in FIG. 3. The scenario repository 306 can call into the language parser 304 so that the language parser can retrieve the transformation information from the collection of animation definitions 302. Alternately, the scenario repository 306 can retrieve the transformation information from the collection of animation definitions 302 directly. Once the transformation information is retrieved, step 808 returns the transformation information to the calling application.

Step 810 receives the transformation information and step 812 calls the animation library and requests an animation definition for the scenario. It is to be appreciated and understood that instead of separate calls, one call can be made instead. In at least some embodiments, this call requests an XML definition for the particular animation associated with the current scenario.

Step 814 receives the call requesting the animation definition and processes the call accordingly. Processing can take place in any suitable way. For example, the call can be received by a scenario repository, such as scenario repository 306 in FIG. 3. The scenario repository 306 can call into the language parser 304 so that the language parser can retrieve the animation definition from the collection of animation definitions 302. Alternately, the scenario repository 306 can retrieve the animation definition from the collection of animation definitions 302 directly. Once the animation definition is retrieved, step 816 returns the animation definition to the calling application.

Step 818 receives the animation definition and step 820 builds an associated storyboard and implements the animation as defined in the animation definition.

Having described an example method in accordance with one or more embodiments, consider now a discussion of an example device that can be utilized to implement the embodiments described above.

Example Device

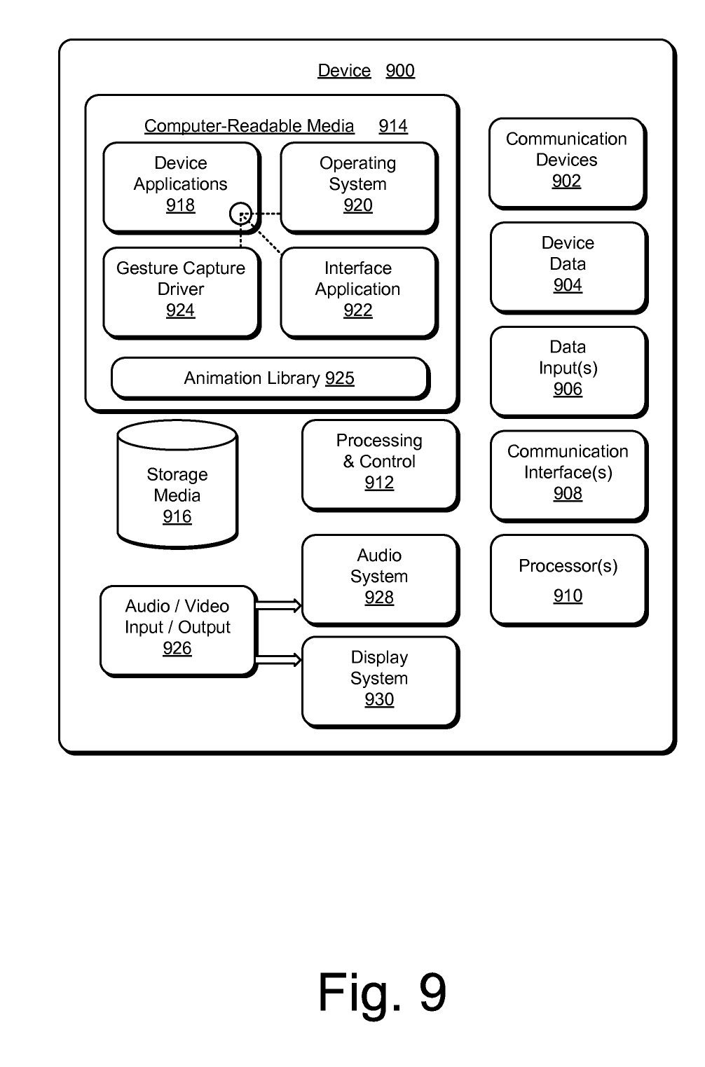

FIG. 9 illustrates various components of an example device 900 that can be implemented as any type of portable and/or computer device as described with reference to FIGS. 1 and 2 to implement embodiments of the animation library described herein. Device 900 includes communication devices 902 that enable wired and/or wireless communication of device data 904 (e.g., received data, data that is being received, data scheduled for broadcast, data packets of the data, etc.). The device data 904 or other device content can include configuration settings of the device, media content stored on the device, and/or information associated with a user of the device. Media content stored on device 900 can include any type of audio, video, and/or image data. Device 900 includes one or more data inputs 906 via which any type of data, media content, and/or inputs can be received, such as user-selectable inputs, messages, music, television media content, recorded video content, and any other type of audio, video, and/or image data received from any content and/or data source.

Device 900 also includes communication interfaces 908 that can be implemented as any one or more of a serial and/or parallel interface, a wireless interface, any type of network interface, a modem, and as any other type of communication interface. The communication interfaces 908 provide a connection and/or communication links between device 900 and a communication network by which other electronic, computing, and communication devices communicate data with device 900.

Device 900 includes one or more processors 910 (e.g., any of microprocessors, controllers, and the like) which process various computer-executable or readable instructions to control the operation of device 900 and to implement the embodiments described above. Alternatively or in addition, device 900 can be implemented with any one or combination of hardware, firmware, or fixed logic circuitry that is implemented in connection with processing and control circuits which are generally identified at 912. Although not shown, device 900 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 900 also includes computer-readable media 914, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 900 can also include a mass storage media device 916.

Computer-readable media 914 provides data storage mechanisms to store the device data 904, as well as various device applications 918 and any other types of information and/or data related to operational aspects of device 900. For example, an operating system 920 can be maintained as a computer application with the computer-readable media 914 and executed on processors 910. The device applications 918 can include a device manager (e.g., a control application, software application, signal processing and control module, code that is native to a particular device, a hardware abstraction layer for a particular device, etc.), as well as other applications that can include, web browsers, image processing applications, communication applications such as instant messaging applications, word processing applications and a variety of other different applications. The device applications 918 also include any system components or modules to implement embodiments of the techniques described herein. In this example, the device applications 918 include an interface application 922 and a gesture-capture driver 924 that are shown as software modules and/or computer applications. The gesture-capture driver 924 is representative of software that is used to provide an interface with a device configured to capture a gesture, such as a touchscreen, track pad, camera, and so on. Alternatively or in addition, the interface application 922 and the gesture-capture driver 924 can be implemented as hardware, software, firmware, or any combination thereof. In addition, computer readable media 914 can include an animation library 925 that functions as described above.

Device 900 also includes an audio and/or video input-output system 926 that provides audio data to an audio system 928 and/or provides video data to a display system 930. The audio system 928 and/or the display system 930 can include any devices that process, display, and/or otherwise render audio, video, and image data. Video signals and audio signals can be communicated from device 900 to an audio device and/or to a display device via an RF (radio frequency) link, S-video link, composite video link, component video link, DVI (digital video interface), analog audio connection, or other similar communication link. In an embodiment, the audio system 928 and/or the display system 930 are implemented as external components to device 900. Alternatively, the audio system 928 and/or the display system 930 are implemented as integrated components of example device 900.

### CONCLUSION

Various embodiments provide a library of animation descriptions based upon various common user interface scenarios. Application developers can query the animation library for animations based on a user's interaction with the user interface. The library defines usage of transformation primitives, storyboarding of the transformation primitives and associated timing functions that are used to create particular animations. These definitions can be provided to a calling application so that the application can implement an animation that utilizes the storyboarded transformation primitives.

Utilizing the animation library, application developers can map scenarios in their particular user interfaces to matching animations without necessarily understanding the specifics behind a particular animation. This abstraction not only simplifies an application developer's task, but it also allows the animation design to be consistently applied across a particular system.

Although the embodiments have been described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

What is claimed is:

1. A method comprising:
receiving a user interaction associated with an application user interface;
ascertaining, responsive to receiving the user interaction, one or more affected targets;
calling an animation library to request an animation definition for a scenario associated with the user interaction and pertaining to the one or more affected targets;
receiving, from the animation library, an animation definition for the scenario; and
building, using the animation definition, a storyboard configured to implement an animation associated with the scenario.

2. The method of claim 1, wherein said receiving is performed by receiving the user interaction through the form of a gesture.

3. The method of claim 1 further comprising, prior to calling the animation library to request the animation definition, calling the animation library to request transformation information associated with the particular scenario.

4. The method of claim 1 further comprising, prior to calling the animation library to request the animation definition, calling the animation library to request transformation information associated with the particular scenario and including a storyboard ID and one or more target names.

5. The method of claim 1, wherein calling the animation library to request the animation definition comprises calling the animation library to request an XML animation definition.

6. The method of claim 1 further comprising implementing the animation using the storyboard.

7. One or more computer readable storage media embodying a callable animation library comprising a collection of animation definitions, individual animation definitions being associated with individual respective user interface scenarios, individual animation definitions being expressed in a standardized language;
at least some of the animation definitions including at least one timing function and storyboard content that includes one or more target names and one or more transforms,
the at least one timing function and the storyboard content being configured to be used by a calling application to build a storyboard and implement an associated animation associated with a user interface scenario.

8. The one or more computer readable storage media of claim 7, wherein the standardized language comprises XML.

9. The one or more computer readable storage media of claim 7, wherein at least some animation definitions can be utilized to operate on multiple elements.

10. The one or more computer readable storage media of claim 7, wherein at least some animation definitions can be utilized to operate on arrays of elements.

11. The one or more computer readable storage media of claim 7, wherein the animation library is platform-agnostic.

12. The one or more computer readable storage media of claim 7, wherein at least some user interface scenarios comprise gestural input scenarios.

13. The one or more computer readable storage media of claim 7, wherein at least some user interface scenarios comprise gestural touch input scenarios.

14. One or more computing devices embodying the one or more computer readable storage media of claim 7.

15. The one or more computer readable storage media of claim 7, wherein at least some of the animation definitions include static images.

16. A computer-implemented method comprising:
receiving with an animation library, a call from an application, the call requesting at least one animation definition associated with a user interface scenario associated with an application user interface, the animation definition being configured to enable the application to build a storyboard and implement an associated animation; and
returning, by the animation library and to the application, said at least one animation definition.

17. The method of claim 16, wherein said returning said at least one animation definition comprises returning an animation definition that is rendering- and composition-technology agnostic.

18. The method of claim 16, wherein said returning said at least one animation definition comprises returning an XML animation definition that is rendering- and composition-technology agnostic.

19. The method of claim 16, wherein said animation definition includes at least one timing function and storyboard content that includes one or more target names and one or more transforms, the at least one timing function and the storyboard content being configured to be used by the application to build a storyboard and implement an associated animation associated with the user interface scenario.

20. The method of claim 16, wherein said animation definition includes at least one timing function and storyboard content that includes one or more target names and one or more transforms, the at least one timing function and the storyboard content being configured to be used by the application to build a storyboard and implement an associated animation associated with the user interface scenario, wherein said animation definition includes at least one static image.
